(19) United States
(12) Patent Application Publication
(10) Pub. No.: US 2015/0006125 A1
(43) Pub. Date: Jan. 1, 2015

(54) INVERSE MODELING PROCEDURE FOR BUILDING ENERGY USING INTEGRATED PDE-ODE MODELS AND STEPWISE PARAMETER ESTIMATION

(71) Applicant: International Business Machines Corporation, Armonk, NY (US)

(72) Inventors: Lianjun An, Yorktown Heights, NY (US); Young T. Chae, Yorktown Heights, NY (US); Raya Horesh, Ossining, NY (US); Young Min Lee, Old Westbury, NY (US); Rui Zhang, Ossining, NY (US)

(21) Appl. No.: 13/930,735

(22) Filed: Jun. 28, 2013

(51) Int. Cl. G06F 17/50

(52) U.S. Cl. CPC G06F 17/5009
USPC 703/2

(57) ABSTRACT

Generating a heat transfer model for building energy may comprise developing a PDE model that describes heat transfer through building envelope of a building, and developing an ODE model that describes the heat transfer and thermal balance in a space inside the building. Stepwise parameter estimation integrates the PDE model and the ODE model in generating the heat transfer model.

### FIELD

The present application relates generally to energy efficiency in building, and more particularly to a heat transfer modeling for building energy.

### BACKGROUND

A heat transfer model of a building can be used for evaluating and identifying energy efficient and cost effective building operational settings and control strategies. While commercially available building energy simulation can be used to develop the heat transfer models, they require substantial effort to collect the needed data, which in some cases is not possible. Forward modeling approach for developing the heat transfer model is very time-consuming involving physical audit and architectural and engineering document search and labor intensive model development effort. Inverse modeling approach in the building energy engineering field typically uses systems of ordinary differential equations (ODEs) to describe the heat transfer through building envelope (walls, windows, roof and ground, etc.), and the heat transfer in the spaces inside the building. This ODE-ODE approach may inaccurately model the heat transfer through the building envelope and present difficulty in calibrating the model with dynamic sensor data.

### BRIEF SUMMARY

A method of generating a heat transfer model for building energy, in one aspect, may comprise developing a PDE model that describes heat transfer through building envelope of a building. The method may also comprise developing an ODE model that describes the heat transfer and thermal balance in a space inside the building. A stepwise parameter estimation may integrate the PDE model and the ODE model in generating the heat transfer model.

A system for generating a heat transfer model for building energy, in one aspect, may comprise a heat transfer model generator operable to execute on a processor and further operable to develop a PDE model that describes heat transfer through building envelope of a building. The heat transfer model generator may be further operable to develop an ODE model that describes the heat transfer and thermal balance in a space inside the building. A processor may be operable to perform a stepwise parameter estimation that integrates the PDE model and the ODE model.

A computer readable storage medium storing a program of instructions executable by a machine to perform one or more methods described herein also may be provided.

Further features as well as the structure and operation of various embodiments are described in detail below with reference to the accompanying drawings. In the drawings, like reference numbers indicate identical or functionally similar elements.

### BRIEF DESCRIPTION OF THE SEVERAL VIEWS OF THE DRAWINGS

FIG. 1 illustrates an integrated PDE-ODE calibration procedure in one embodiment of the present disclosure.

FIG. 2 is a flow diagram that illustrates a PDE model solver methodology in one embodiment of the present disclosure.

FIG. 3 is a flow diagram illustrating a process of ODE solver for zone temperature change in one embodiment of the present disclosure.

FIG. 4 illustrates a schematic of an example computer or processing system that may implement the heat transfer model generator system in one embodiment of the present disclosure.

### DETAILED DESCRIPTION

Thermal parameters of building heat transfer model may be estimated via inverse modeling using dynamic sensor data. In one embodiment of the present disclosure, an integrated partial differential equation (PDE)-ODE modeling procedure is developed, wherein the PDE model describes the heat transfer through or cross building envelope (e.g., surface convections, conduction through wall, window, roof and ground), ODE model describes the heat transfer in the spaces inside building, and stepwise estimation of time-invariant parameters and time-variant parameters is applied. Stepwise calibration procedures avoid over fitting; Stepwise parameter calibration reduces co-linearity among parameters.

Misfit across multiple walls and multiple days may be aggregated. Disjoint multi-periods sensor data may be used to cover different conditions (e.g., weather, internal load). Multipliers may be applied to one or more physical parameters. Misfit or a misfit value refers to the difference value between the predicted (or simulated) value and an actual value (or measured valued). Time invariant parameters may include wall conductivity, shading effect of solar radiation on different wall directions. Time variant parameters may for example include equipment, lighting and occupancy varying as daily activity change in the interior zone.

Parameter estimation procedure is performed with dynamic sensor data. Systematic error that exists in sensor deployment process (pseudo-multiplier) may be handled. Time invariant load multiplier for workday and non-workday may be used. The sky condition may be applied dynamically.

This approach allows an efficient and accurate calibration of heat transfer model of buildings using dynamic sensor data (e.g., from building management system (BMS)), and the resulting model may accurately predict energy consumption profiles and indoor temperature profiles. For instance, an inverse approach, of the present disclosure may calibrate heat transfer models for many buildings in automatic fashion based on mostly sensor data collected from each building.

The prediction of energy usage in the building is useful for identifying opportunities for improving energy performance, saving energy consumption and for reducing greenhouse gases (GHG).

In one embodiment of the present disclosure, an approach is presented for developing a dynamic inverse modeling tool that can handle uncertainties by sensor data and can be used as an energy management system (EMS) for commercial buildings. In one embodiment, the developed model is constructed in an automatic fashion by using parameter estimation algorithms which is incorporated with real-time data from building management system (BMS).

For instance, the inverse model is calibrated in an automatic fashion using real time sensor and meter data obtained from BMS. The recovered parameters of heat transfer reflect the current properties (not necessarily the design properties) of building's structures resulting from aging and degrading, and they can be used to determine a dynamic profile of building's energy consumption, to evaluate energy impact of operational alternatives of HVAC systems, and to compute optimal operational settings that optimize the balance between occupant comfort and energy consumption. Techniques for calibrating the inverse model and performing sensitivity analysis to improve and assess the model accuracy are also presented.

More specifically, in one embodiment of the present disclosure, an integrated PDE-ODE model is derived that describes thermal energy balance in various zones in a building. An inversion procedure is disclosed to estimate physical parameters associated with the enclosure of the zones. In addition, an embodiment of the present disclosure provides for estimating a time-dependent function associated with the internal load of the zones by minimizing the misfit between simulated and measured sensor data.

In one aspect, since the model is designed to work with real sensor data in addition to simulated data, the set of parameters that are recovered are carefully chosen to handle uncertainties in the real settings of commercial buildings. For instance, the building under study may be surrounded by other buildings, and due to shading, solar radiation on the different sides of a wall can be different from one another; dynamics profile of internal load might not be available; supply air temperature may not be clearly defined with different heating, ventilation, and air conditioning (HVAC) systems. Some sensor data, such as inner or outer surface temperature of a wall, may not be accurate and may require re-installation of the sensors. In one embodiment of the present disclosure, when recovered parameters are used in simulation, a weighted averaging of the parameters recovered from different calibration periods is properly considered.

In one embodiment of the present disclosure, a calibrating procedure may be designed in two steps. Firstly, multiple initial values are randomly chosen for the optimization procedure to reduce chances of getting a local minimum. Then, a validation step is taken to choose a proper regularization coefficient to avoid data over-fitting. In the present disclosure in one embodiment, a regularization term is added to an objective misfit function in order to avoid over-misfit of the solution to the noise level. In addition, solution space may be restricted and a more smooth temperature profile may be favored, which is a reasonable assumption for this problem.

A formulation of PDE-ODE model that describes heat transfer equations through the building envelope and interior zone is presented below in one embodiment.

PDE-ODE Hybrid Model

The enclosure, which includes a wall, windows, floor and roof of a building (or a zone) provides insulation for the occupied space. Based on thermodynamics principles, heat can transfer through the enclosure (building envelope) in the form of conduction, convection and solar radiation.

Mathematically, wall temperature T_{ws} for the side sε{N, E, S,W, R} satisfies the following PDE

$${ρ}_{w} {C}_{wp} {d}_{ws} \frac{\partial {T}_{ws}}{\partial t} = \frac{\partial }{\partial x} ( {λ}_{k} K \frac{\partial {T}_{ws}}{\partial x} ) , \\ ( x , t ) ∈ ( 0 , {d}_{ws} ) \times ( {t}_{0} , {t}_{f} ) \qquad ( 1 )$$

with boundary conditions

$$\begin{matrix}{λ}_{k} K \frac{\partial {T}_{ws}}{\partial x} ( 0 , t ) = - {λ}_{eh} {h}_{os} ( {T}_{amb} ( t ) - {T}_{ws} ( 0 , t ) ) - {λ}_{ws} {Q}_{sol} ( t ) + ( {λ}_{eos} - 1 ) {σ ( {T}_{0} + {T}_{ws} ( 0 , t ) )}^{4} & ( 2 ) \\ {λ}_{k} K \frac{\partial {T}_{ws}}{\partial x} ( {d}_{ws} , t ) = {λ}_{ih} {h}_{is} ( {T}_{zone}^{sen} ( t ) - {T}_{ws} ( {d}_{ws} , t ) ) - ( {λ}_{eis} - 1 ) {σ ( {T}_{0} + {T}_{ws} ( {d}_{ws} , t ) )}^{4} & ( 3 )\end{matrix}$$

The wall sides comprise the north side (N), the east side (E), the south side (S), the west side, and the top, for example, a roof side (R). t₀ represent beginning of a time period and t_{f} represent the end (finish) of the time period being considered. The heat flux at wall surfaces has the convection driven by the difference between ambient air temperature and surface temperature, solar radiation on a wall and heat radiated from the wall. In equations (1)-(3), ρ_{w} is wall density, C_{wp} is specific heat of wall, hₒₛ, hᵢₛ are convection coefficients which are functions of surrounding wind speed and temperature difference. K is wall conductivity; Qₛₒₗₛ solar radiation; d_{ws} represents the thickness of wall, subscript s means that its value is different for each wall direction; σ is the Stefan-Boltzmann constant. T₀=273.15° K is the absolute temperature corresponding to 0° C. T_{amb}, T_{zone}^{sen} are ambient and zone temperature respectively. Multipliers λₖ, λᵢₕ, λₑₕ are for conductivity and internal and external convection respectively. In one embodiment of the present disclosure, no side of wall dependence is assumed here. Multiplier λ_{ws} is for heat absorption coefficient, which is different for different sides, since each wall might be under different shading effect from nearby buildings or trees and with different color and smoothness. The multipliers λₑₒₛ, λₑᵢₛ are used to adjust external and internal wall heat radiation. In one embodiment of the present disclosure, assuming there is a good estimation for the physical parameters, it is expected that all λ's value to be close to 1. In such case, the whole factor for heat radiation could be negative. As a matter of fact, wall surface temperature reading from sensor is most likely to be inaccurate, and strongly depend on sensor location. In one embodiment of the present disclosure, this term may be treated as a kind of artificial term to handle a systemic and consistent error resulting from improper-emplacement of surface sensors.

Temperature T_{zone} inside a zone satisfies the following ODE

$$\begin{matrix}{λ}_{ac} {ρ}_{air} {C}_{ap} {V}_{zone} \frac{d {T}_{zone} ( t )}{d t} = \\ {λ}_{ih} {\sum }_{s} {h}_{is} {A}_{ws} ( {T}_{ws} ( {d}_{ws} , t ) - {T}_{zone} ( t ) ) + \\ {\sum }_{s} ( {λ}_{eis} - 1 ) {σ ( {T}_{0} + {T}_{ws} ( {d}_{ws} , t ) )}^{4} + \\ {λ}_{gu} {\sum }_{s} {U}_{gs} {A}_{gs} ( {T}_{amb} ( t ) - {T}_{zone} ( t ) ) + \\ {λ}_{inf} {ρ}_{air} {C}_{ap} {\dot{M}}_{inf} ( {T}_{amb} ( t ) - {T}_{zone} ( t ) ) + \\ {λ}_{shgc} {\sum }_{s} {λ}_{ws} {Q}_{sol} {A}_{gs} + {λ}_{load} {Q}_{load} + \\ {ρ}_{air} {C}_{ap} {\dot{M}}_{sys} ( {T}_{sys} ( t ) - {T}_{zone} ( t ) )\end{matrix} \qquad ( 4 )$$

Where ρₐᵢᵣ is density of air, Cₐₚ is specific heat of air, V_{zone} is zone volume, A_{ws} and A_{gs} are areas of wall and window respectively, U_{gs} is U-value of window, \dot{M}_{inf} is infiltration rate and \dot{M}_{sys} is Air Handling Unit (AHU) supply air flow rate. Q_{load} is internal load, including contribution from lighting, electric equipment and occupants, T_{sys} is the system supply air temperature. Multipliers λ_{ac}, λ_{gu}, λ_{inf}, λ_{shge}, λ_{load} are for air heat capacity, for U-value of window, for air infiltration rate, for solar heat gain coefficient through window and for internal load respectively.

The first two terms in the right hand side represent convection and heat radiation contribution from different walls. The internal wall temperature T_{ws} and the multipliers λᵢₛ and λₑᵢₛ were established during calibrating of the above PDE system. The third term stands for heat conduction through windows. The fourth term stands for air infiltration through building enclosure. The fifth term is for solar radiation contribution through window. The sixth term is for internal load. The multiplier λ_{load} can be vary depending on time of a day. A piecewise constant function is chosen with a constant value for every three hours in a day. The seventh term is for system supplied energy, which is used to maintain the comfort level of zone temperature. In one embodiment of the present disclosure, heat contribution through window is modeled differently compared with the heat transfer through wall, and is modeled directly through the third and fifth terms in equation (4), because window heat capacity is much smaller than wall heat capacity. The value of λ_{ac} reflects wall partition, furniture and equipment layout inside the zone. Both λ_{gu} and λ_{inf} are factors of terms containing T_{smb}(t)−T_{zone}(t), and would be correlated in current model.

In one embodiment of the present disclosure, a numerical PDE solver may be implemented for the parabolic equation using Crank-Nicolson scheme and an ODE solver may be implemented using implicit Euler scheme. Both numerical algorithms for solving the above PDE and ODE equations with given multipliers' values are unconditionally stable due to implicit nature on time-step evolution.

Calibration Procedure

An embodiment of the calibration procedure for the inverse model is now described. The multipliers are estimated through solving a minimization problem in one embodiment of the present disclosure. The overall procedure may comprise two steps to overcome correlations among multipliers.

Minimization with PDE Constraint

In one embodiment of the present disclosure, an inversion procedure for parameters estimation is posed as a minimization of the objective function defined by

$${min}_{{λ}_{i}} {\sum }_{k} {\sum }_{s} ⌊ {( {T}_{ws} ( 0 , {t}_{k} ; λ ) - {T}_{wos}^{sen} ( {t}_{k} ) )}^{2} + {( {T}_{ws} ( {d}_{ws} , {t}_{k} ; λ ) - {T}_{wis}^{sen} ( {t}_{k} ) )}^{2} ⌋ + η {\sum }_{i} {( {λ}_{i} - 1 )}^{2} \qquad ( 5 )$$

subject to the PDE constrained as in (1) with boundary condition (2) and (3), by choosing proper multipliers

{λᵢ}={λₖ,λᵢₕ,λₑₕ,λ_{ws},λₑₒₛ,λₑᵢₛ∥sεN,S,E,W,R} (6)

where T_{ws}(x,t;λ) is a solution of PDE defined in (1) with boundary conditions (2) and (3), T_{wos}^{sen}(t) is sensor data of outside wall surface temperature and T_{wis}^{sen}(t) is sensor data for inside wall surface temperature. The first term represents the sum of squared differences between simulated outside wall surface temperature and measured outside wall surface temperature—a misfit measure for outside wall surface temperature. Similarly, the second term represents the same misfit measure for inside wall surface temperature. A goal in the equations (5) and (6) is to find a set of multipliers so that the misfit defined by first two terms is minimized. In order to avoid over-fit to the noisy available data, a regularization term, the third term in the objective function (5), is included. Since those multipliers are multiplying factors of well-defined nominal physical value, they are expected to be close to one.

There may be two challenges in this optimization problem. First, the objective may not be a convex function and a local minimum may be achieved. To address this, an embodiment of a method in the present disclosure randomizes the initial guess for these multipliers and performs the optimization multiple times. The method of the present disclosure in one embodiment may choose the solution that obtained the minimal objective function value. Second, the solution may result from over-tuning the model from sensor data for the chosen period, since real sensor data is likely to contain errors and operation condition might different from an expected one. The solution corresponding to the least misfit for specific period is not necessarily a good solution for other periods and the misfit could become larger when applying the recovered multipliers on other periods. The regularization term helps to address this issue through choosing a proper regularization coefficient. Since it may not be possible to test all different regularization coefficients over a large range, the method of the present disclosure in one embodiment may pick the coefficient η from a discrete set {0.1,0.01,0.001,0.0001,0.00001} that covers different order of values.

In one embodiment, the objective function may include misfits from all walls, but may be subject to the same multipliers for conductivity and convection. In this way, the method of the present disclosure in one embodiment may also reduce the possibility of over-fitting certain biased sensor data. In another aspect, another statistical sample may be utilized to resolve the over-tuning issue.

Minimization with ODE Constraint

In one embodiment of the present disclosure, the additional multipliers

{λ′ᵢ}={λ_{ac},λ_{gu},λ_{inf},λ_{shge},λ_{load}} (7)

are chosen to minimize the following objective function, i.e.

$${min}_{{λ}_{i}^{′}} {\sum }_{k} {( {T}_{zone} ( {t}_{k} ; {λ}^{′} ) - {T}_{zone}^{sen} ( {t}_{k} ) )}^{2} + {η}^{′} {\sum }_{i} {( {λ}_{i}^{′} - 1 )}^{2} \qquad ( 8 )$$

subject to the ODE constrained as in (4), where T_{zone}(t;λ′) is the ODE solution of equation (4) and T_{zone}^{sen}(t) is sensor data of zone temperature. The first term in the objective (8) represents a misfit of zone temperature between simulated and measured and the second term is for regularization term. Similar procedure described above with respect to the minimization with PDE constraint may be utilized to find these additional multipliers defined in (7). In one embodiment of the present disclosure, the multiplier λ_{ac} could be greater than one, since there are internal partitioning walls, furniture inside a zone and etc., and the multiplier λ_{load} is a function of time in a day.

Stepwise Calibration

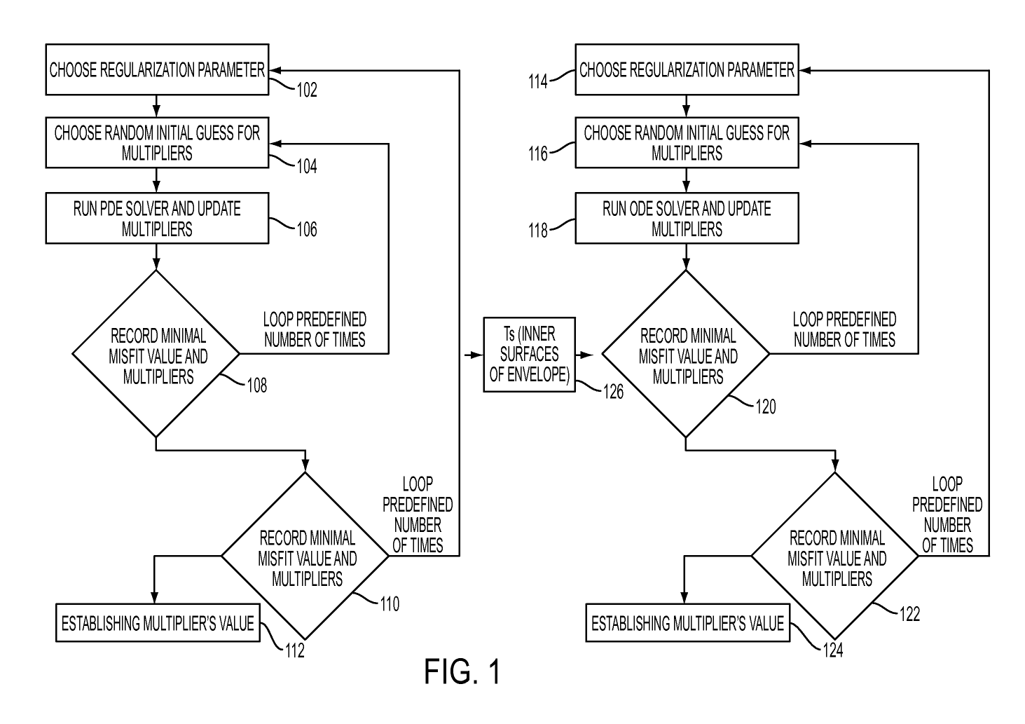

FIG. 1 illustrates the calibration procedure in one embodiment of the present disclosure. First, the minimization problem with PDE constraint is solved and a set of multipliers related to building envelope are recovered. Second, the minimization problem with ODE constraint is solved and additional multipliers are recovered to estimate internal load impact. The second minimization will use at least some of the information coming from the first minimization problem, like thermal energy consumption related to building envelope.

The left part of FIG. 1 shows calibration procedure through minimization with PDE constraint. There are two loops in the procedure. The inner loop is used to get a solution with the least objective value on the train data for multiple random initial guesses with a given regularization coefficient in order to achieve a global minimum. The outer loop is used to get a solution with the least misfit with different regularization coefficients in order to avoid an over-fitting situation. The right part of FIG. 1 shows calibration procedure through minimization of the objective with ODE constraint.

For the solution of the minimization problem, the method of the present disclosure in one embodiment may use constrained nonlinear multivariable optimization method, e.g., within MATLAB, namely fmincon.

When solving the minimization problem with PDE constraint, the method of the present disclosure in one embodiment not only may estimate multipliers related to building envelope, but also find out heat-contribution from the internal walls to the zone. Heat gain or loss through building envelope is substituted into the ODE model. With measured system contribution from air heating unit (AHU) data, the method of the present disclosure in one embodiment can estimate internal load change during the day. For example, the load multiplier is found as a function of time of the day. The stepwise calibration in one embodiment of the present disclosure reduces impact from correlation among multipliers. It helps to discover energy consumption distribution between building envelope and internal load more accurately.

Referring to FIG. 1, at 102, a regularization parameter is chosen from a discrete set {0.1,0.01,0.001,0.0001,0.00001} that covers different order of values.

At 104, initial values are randomly chosen from a uniform distribution around 1 for multipliers of the PDE model, e.g., equations (1)-(3).

At 106, PDE solver is run (e.g., equations (1)-(3)), using the initial values subject to constraints in equation (5). The PDE is solved for wall's temperature profile.

At 108, minimal misfit value and associated multipliers computed for a time period are recorded. If this is the first run of the PDE solver at 106, then the minimal misfit value would be the current run's value. The processing returns to 104, where different random initial values are chosen, and the processes of 106 and 108 repeated. The iteration of 104, 106 and 108 is performed for a predefined number of times for the same time period. This predefined number of iteration may be chosen by a user.

At 110, minimal misfit value and associated multipliers that produced the minimal misfit are recorded. The processing then returns to 102, where a different regularization parameter is chosen. The processings at 104, 106, 108 and 110 are repeated for a predefined number of times, e.g., for each number in a set {0.1,0.01,0.001,0.0001,0.00001}.

At 112, multiplier values are determined. For example, a set of values resulting from a regularization parameter that provides minimal misfit value are established as multipliers for the PDE model.

The processing at 102, 104, 106, 108, 110 and 112 develops a PDE model. The outer loop (e.g., 102, 104, 106, 108, 110) loops through different regularization parameters. For each regularization parameter, the inner loop (e.g., 104, 106, 108) loops through different randomized initial values (also referred to as guess) for the multipliers. For each regularization parameter and initial guess, wall PDE as in (1) with boundary conditions (2) and (3) is solved. A set of multipliers are chosen from the solution (PDE model run) that produced the least misfit.

The processing at 114, 116, 118, 120, 122 and 124 develops an ODE model. The ODE model may be generated using values from the PDE model, for example, values associated with inner surfaces of envelope, Tₛ (shown at 126 in FIG. 1). So, for example, the calculated temperature of inner surface computed from PDE model with the established multipliers is used in ODE model to compute zone temperature T_{zone}, to determine the rest of multipliers and to balance contribution from envelope and internal load gain.

At 114, a regularization parameter is chosen.

At 116, random initial value is chosen for multipliers of the ODE model, e.g., equation (4).

At 118, the ODE solver is run, e.g., equation (4) subject to constraints of equation (5).

At 120, minimal misfit value and associated multiplier for a time period are recorded. If this is the first run of the ODE solver at 118, then the minimal misfit value would be the current run's value. At the end of the iteration of 116, 118 and 120, minimal misfit value and associated multipliers that produced the minimal misfit value are established.

At 122, the current minimal misfit value and associated multipliers are recorded. The processing returns to 114 where another regularization parameter is chosen. The processing of 114, 116, 118, 120, 122 repeats for a predefined number of times, loops through with different regularization parameter at each iteration. For each regularization parameter, the processing at 116, 118 and 120 loop through different randomized initial guesses for the multipliers. The processing at 120 solves wall ODE as in (4) for each regularization parameter and initial guess. After the predefined number of iterations, the minimal misfit value and associated multipliers determined at 122 are established at 124 as the ODE model's multiplier values.

As discussed above, an integrated PDE-ODE modeling procedure is developed wherein a PDE model describes the heat transfer through building envelope (e.g., surface convections, conduction of wall, window, roof and ground) and an ODE model describes the heat transfer in the spaces inside a building, and wherein stepwise estimation of time-invariant parameters and time-variant parameters is applied. This approach in one embodiment may allow for an efficient and accurate calibration of heat transfer model of buildings using dynamic sensor data, and the resulting model may accurately predict energy consumption profiles and indoor temperature profiles.

Stepwise calibration procedures in one embodiment of the present disclosure avoid over fitting. For example, a stepwise parameter calibration reduces co-linearity among parameters, misfit may be aggregated across multiple walls and multiple days, disjoint multi-periods sensor data may be used to cover different conditions (e.g., weather, internal load).

In one embodiment of the present disclosure, multipliers are applied to a plurality of physical parameters, e.g., time invariant parameters which may comprise wall conductivity, shading effect of solar radiation on different wall directions, and time variant parameters which may comprise equipment, lighting and occupancy vary as daily activity change in the zone.

Parameter estimation procedure may be performed with dynamic sensor data, which may allow for handling systematic error that exists in sensor deployment process (pseudo-multiplier), using time invariant load multiplier for workday and non-workday, and adjusting the sky condition dynamically.

An approach of the present disclosure combines PDE and ODE to model heat transfer into a zone. For example, PDE is used for thermal conduction through building walls; and ODE is used for temperature change inside a zone. In one embodiment of the present disclosure, inversion procedure is separated for two sets of parameter recovery, e.g., to reduce impact from co-linearity.

For time invariant thermal parameters, multiple days data (e.g., including working days and non-working days) may be used to avoid over-fitting certain days operation condition, misfit for all walls may be minimized together to avoid over-fitting effect from a particular side, cross-validation step may be used to determine the coefficient of regularization.

For time variant solar impact, different multiplier may be allowed for solar radiation since different day can have different sky condition, and different multiplier may be allowed for different sides of a wall to account for different shading conditions.

For time variant load estimation, different multipliers may be allowed to be estimated for different hours in a given day to work with real data, and different set of multipliers may be allowed for working and non-working days.

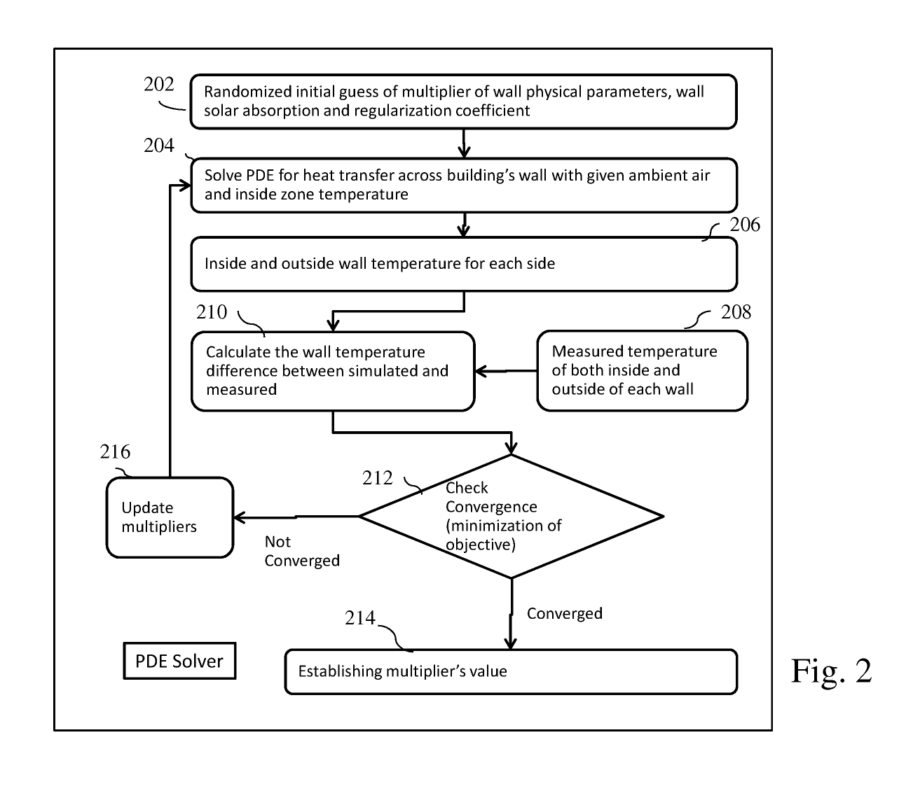

FIG. 2 is a flow diagram that illustrates a PDE model solver methodology in one embodiment of the present disclosure. This process estimates multipliers of physical parameters through minimizing the difference between simulated and measured temperature profiles of walls (inner and outer surfaces). Multipliers may include heat conductivity of a wall (same for different sides of a wall), solar impact on different sides of the wall that accounts for different shading effect from neighboring buildings and the like, solar impact for different days or times. Misfit may include differences from all side of walls, e.g., to avoid over fitting. At 202, randomized initial guess of multiplier of wall physical parameters, wall solar absorption and regularization coefficient are received. At 204, the PDE model is solved for heat transfer across a building's wall with given ambient air and inside zone temperature. At 206, inside and outside wall temperature for each side are determined from the solution of the PDE model. At 208, measured temperature of both inside and outside of each side of the wall are received. At 210, the wall temperature difference between the simulated or predicted value (206) and measured value (208) is calculated. At 212, it is determined whether there is convergence, i.e. the difference from (210) is smaller than user's pre-defined tolerance. If there is convergence, multiplier values are established at 214 based on the solution of the PDE model. If there is no convergence, multipliers may be updated using an algorithm of choice (for example based on gradient size) at 216 and the process returns to 204 to repeats the procedure.

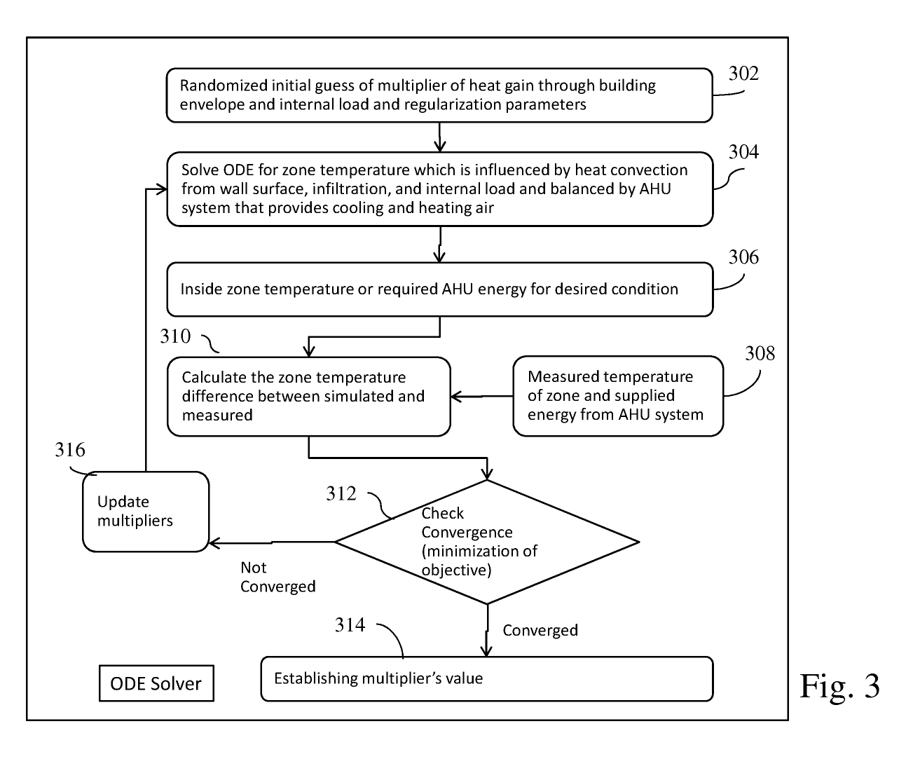

FIG. 3 is a flow diagram illustrating a process of ODE solver for zone temperature change in one embodiment of the present disclosure. The process in one embodiment estimates multipliers of physical parameters associated with heating gain through building envelope and with internal heat gain. Multipliers may include overall convection from inside wall surfaces, solar heat gain through window, infiltration though opening crack of building envelope or the like, internal heat gain from occupancy's bodies if any, lighting and other equipment if any, which might be time-dependent. Misfit may include zone temperature differences between simulated and measured values.

At 302, randomized initial guess of multipliers of heat gain through building envelope and internal load, and regularization parameters are received. At 304, the ODE model is solved for zone temperature. The zone temperature is influenced by heat convection from a wall surface, infiltration, and internal load and is balanced by AHU system that provides cooling and heating air. At 306, the inside zone temperature and/or the required AHU energy for the desired condition is received, for example, from solving the ODE model at 304. At 308, measured temperature of zone and/or supplied energy from AHU system is received. At 310, the zone temperature difference between simulated (306) and measured (308) values is calculated. At 312, it is determined whether there is convergence to user's predefined tolerance of the zone temperature difference. If there is convergence, multiplier values are established at 314 based on the solution of the ODE model. If there is no convergence, multipliers may be updated at 316 using an algorithm of choice (for example based on gradient size) and the process returns to 304 to repeat the procedure.

Simulation Method

After recovering multipliers through calibration using sensor data, a method of the present disclosure in one embodiment can use the integrated PDE-ODE model to simulate zone temperature dynamics and conduct what-if analysis, in addition different control strategies can be evaluated to meet comfortable level requirement.

There may be two approaches for solving the coupled system of ODE and PDE equations. The first approach is to solve PDE and ODE together and to obtain wall surface temperature and zone temperature under a given ambient temperature from weather forecast. The second approach is to solve PDE and ODE iteratively. First, e.g., with an initial guess of zone temperature, the method of the present disclosure in one embodiment may solve the PDE and obtain internal wall surface temperature. Second, e.g., the method of the present disclosure in one embodiment may solve the ODE with the internal wall surface temperature obtained from the solution of the PDE and obtain a new zone temperature. Then the method of the present disclosure in one embodiment may solve the PDE again with the new zone temperature coming from solution of the ODE. That procedure may be iterated several times until convergence.

When solving the ODE, in one embodiment, AHU supply air flow rate and supply temperature \dot{M}_{sys},T_{sys} for these simulations should be known. The purpose of air handling units is to adjust temperature and humidity inside a zone and maintain a comfortable climate for occupants. For a constant air volume (CAV) system, it may be only needed to determine supply air temperature. In order to achieve this, the method of the present disclosure in one embodiment may define the following objective function as

$$\begin{matrix}Func ( {T}_{sys} ) = \\ {C}_{cp} {\int }_{{t}_{1}}^{{t}_{2}} ( 1 - p ( t ) ) {{\dot{M}}_{sys} ( {T}_{sys} ( t ) - {T}_{zone} ( t ; {T}_{sys} ) )}^{\pm } d t + \\ {C}_{cp} {\int }_{{t}_{1}}^{{t}_{2}} p ( t ) {{\dot{M}}_{sys} ( {T}_{sys} ( t ) - {T}_{amb} ( t ) )}^{\pm } d t + \\ μ {\int }_{{t}_{1}}^{{t}_{2}} sign ( {\dot{M}}_{sys} ) {\vert {T}_{zone} ( t ; {T}_{sys} ) - {T}_{sp} ( t ) \vert}^{2} d t + \\ μ {\int }_{{t}_{1}}^{{t}_{2}} ( 1 - sign ( {\dot{M}}_{sys} ) {\vert {T}_{sys} \vert}^{2} d t\end{matrix} \qquad ( 9 )$$

Here T_{zone}(t;T_{sys}) stands for zone temperature resulting from the ODE corresponding to a given T_{sys}. Tₛₚ is a specified temperature set point which may vary over time. p is fresh air fraction when both ventilation and circulation are in operation and can be specified based on ventilation strategy. μ is the weight for meeting set point requirement. The first two terms represent thermal energy requirement and, for example, it can be a cooling or heating energy depending on a positive or negative part of the difference in the integrand. The first term represents air circulating, which is driven by the difference between return air temperature and supply air temperature T_{sys}; the second term represents air ventilation, which is driven by the difference between ambient air temperature and supply air temperature T_{sys}. The third term in the objective measures the difference between zone temperatures and set point temperature. sign(\dot{M}_{sys}) is an indicator function, whose value is 1 if \dot{M}ₛₛ>0 and 0 otherwise. With this factor in the third term, it implies that set point temperature is targeted only during air handling unit (AHU) system being on period. The fourth term is used to force T_{sys}=0 during AHU system being off. By choosing an appropriate μ value, the method of the present disclosure in one embodiment may balance between energy saving and comforting level of the zone. The objective function can be modified to incorporate other consideration, like humidity requirement, pre-cooling and pre-heating, and entropy control.

Use Case

The heat transfer inverse modeling approach described above in one embodiment of the present disclosure may be applied to a building, e.g., a commercial building. For example, the exterior of the building and geometry of a typical floor and other building's characteristics may be measured. In such a building, e.g., to satisfy indoor thermal requirement of the space, each floor might have both constant air volume (CAV) system and electric heat pump (EHP) system. A main BMS system may control the CAV system, while occupants are allowed to operate individual indoor unit of EHP system for local thermal control. A two-stage absorption chiller may be operating to produce chilled and hot water for heating and cooling coils in the air handling unit (AHU). Using this information, the inverse model of the present disclosure in one embodiment may recover the desired parameter values. A simulation model (e.g., EnergyPlus model) may be developed to validate the values of the parameter recovered by the inverse model.

The sensor and meter data used in the model calibration may be obtained, e.g., from a plurality of temperature sensors, e.g., installed on inside and outside of each exterior wall. A database (e.g., a relational database) may store the dynamic data (the sensor data) measured per every time interval (e.g., every 15 minute intervals), and static data set which may include hourly (or another time period) occupant density and lighting power pattern. A local weather data (for a time period with a defined resolution) may be also tabulated into the database, for example, from on-line local weather forecasting service or national weather administration or the like.

When working with real sensor data from on-site measurement, data quality may be suspect, e.g., uncertainty of weather forecasting and sensor/meter data errors. Wall surface and zone temperature reading may not correctly be recorded depending on where the sensors are installed. In addition, there may be multiple HVAC systems, AHU and EHP systems, that are operating simultaneously, so it is not simple to capture the operational characteristics of different systems independently. Data quality of weather forecasting also impacts the model performance. Although local weather station may generate data of outdoor air temperature, relative humidity, wind speed, sky condition, and precipitation, the information of direct and diffuse solar radiation may not be available from the weather forecasting service. A typical meteorological year (TMY) data of the location may be used and adjusted based on the provided forecast of the sky condition.

Thermal energy requirement in various operating conditions may be simulated. Simulation provides user the capability to specify various operation conditions and requirement and conduct what-if and trade-off analysis. The simulation helps users identifying appropriate balance between energy saving and comfort level in various operational conditions.

As discussed above, an integrated PDE-ODE model describes heat transfer through building envelope and thermal balance inside zones. This model may capture heat transfer phenomena in buildings more accurately than the reduced order models. Multipliers of parameters are introduced to the system and are estimated through a calibration procedure in one embodiment of the present disclosure. By defining an objective function with misfit term from all sides of walls and a regularization term, the method of the present disclosure in one embodiment may improve the robustness of the procedure and avoid over-fitting to a certain set of sensor data. By separating calibration and parameters recovery procedure into two step processes, with first step as wall surface PDE calibration and second step as zone temperature ODE calibration, the method of the present disclosure in one embodiment may reduce the chance for parameter correlation. Simulation procedure, that utilizes the PDE-ODE model with the recovered multipliers and realized zone temperature control, may be also formulated through optimization. This procedure may generate energy demand profile under a given weather condition.

In another aspect, the model of the present disclosure may be integrated with statistical tools. A distribution of the misfit value and a response surface may be obtained, based on the most likelihood calculation. When new sensor data becomes available, the respond surface would be updated using Bayesian updating procedure. In this way, the robustness of the inversion procedure may be further achieved. In one embodiment, the simulation would use a distribution associated with the parameters, e.g., rather than using a point value.

In yet another aspect, the analyses from different scales may be combined: thermal energy demand in daily level (e.g., a first time period level), and dynamical behavior in hourly level (e.g., a second time period level). Statistical forecast can generate daily level energy demand with reasonable accuracy. A PDE-ODE model simulates energy consumption profile in finer resolution than the statistical model. The objective function for the simulation may include not only meeting an hourly specified temperature set point but also aligning daily thermal energy consumption with the forecasted one from a statistical method.

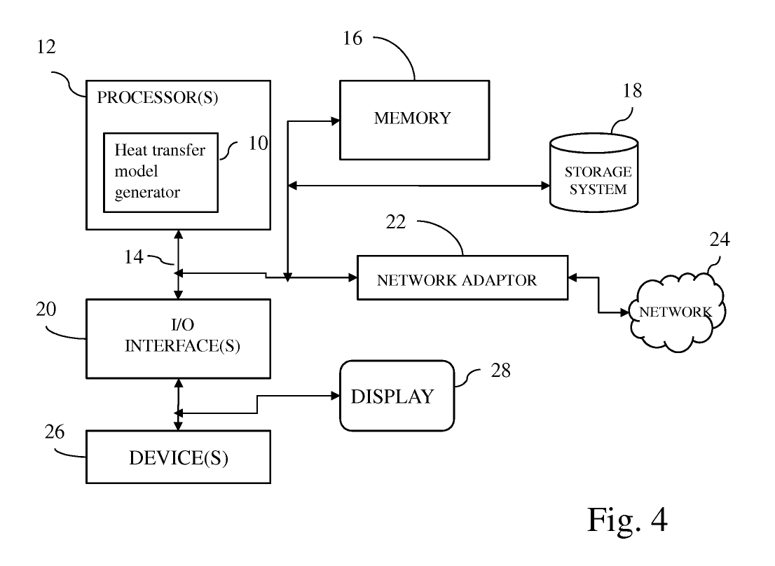

FIG. 4 illustrates a schematic of an example computer or processing system that may implement the heat transfer model generator system in one embodiment of the present disclosure. The computer system is only one example of a suitable processing system and is not intended to suggest any limitation as to the scope of use or functionality of embodiments of the methodology described herein. The processing system shown may be operational with numerous other general purpose or special purpose computing system environments or configurations. Examples of well-known computing systems, environments, and/or configurations that may be suitable for use with the processing system shown in FIG. 4 may include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

The computer system may be described in the general context of computer system executable instructions, such as program modules, being executed by a computer system. Generally, program modules may include routines, programs, objects, components, logic, data structures, and so on that perform particular tasks or implement particular abstract data types. The computer system may be practiced in distributed cloud computing environments where tasks are performed by remote processing devices that are linked through a communications network. In a distributed cloud computing environment, program modules may be located in both local and remote computer system storage media including memory storage devices.

The components of computer system may include, but are not limited to, one or more processors or processing units 12, a system memory 16, and a bus 14 that couples various system components including system memory 16 to processor 12. The processor 12 may include a heat transfer model generator module 10 that performs the methods described herein. The module 10 may be programmed into the integrated circuits of the processor 12, or loaded from memory 16, storage device 18, or network 24 or combinations thereof.

Bus 14 may represent one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system may include a variety of computer system readable media. Such media may be any available media that is accessible by computer system, and it may include both volatile and non-volatile media, removable and non-removable media.

System memory 16 can include computer system readable media in the form of volatile memory, such as random access memory (RAM) and/or cache memory or others. Computer system may further include other removable/non-removable, volatile/non-volatile computer system storage media. By way of example only, storage system 18 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 14 by one or more data media interfaces.

Computer system may also communicate with one or more external devices 26 such as a keyboard, a pointing device, a display 28, etc.; one or more devices that enable a user to interact with computer system; and/or any devices (e.g., network card, modem, etc.) that enable computer system to communicate with one or more other computing devices. Such communication can occur via Input/Output (I/O) interfaces 20.

Still yet, computer system can communicate with one or more networks 24 such as a local area network (LAN), a general wide area network (WAN), and/or a public network (e.g., the Internet) via network adapter 22. As depicted, network adapter 22 communicates with the other components of computer system via bus 14. It should be understood that although not shown, other hardware and/or software components could be used in conjunction with computer system. Examples include, but are not limited to: microcode, device drivers, redundant processing units, external disk drive arrays, RAID systems, tape drives, and data archival storage systems, etc.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages, a scripting language such as Perl, VBS or similar languages, and/or functional languages such as Lisp and ML and logic-oriented languages such as Prolog. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The computer program product may comprise all the respective features enabling the implementation of the methodology described herein, and which—when loaded in a computer system—is able to carry out the methods. Computer program, software program, program, or software, in the present context means any expression, in any language, code or notation, of a set of instructions intended to cause a system having an information processing capability to perform a particular function either directly or after either or both of the following: (a) conversion to another language, code or notation; and/or (b) reproduction in a different material form.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Various aspects of the present disclosure may be embodied as a program, software, or computer instructions embodied in a computer or machine usable or readable medium, which causes the computer or machine to perform the steps of the method when executed on the computer, processor, and/or machine. A program storage device readable by a machine, tangibly embodying a program of instructions executable by the machine to perform various functionalities and methods described in the present disclosure is also provided.

The system and method of the present disclosure may be implemented and run on a general-purpose computer or special-purpose computer system. The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, and/or server. A module may be a component of a device, software, program, or system that implements some “functionality”, which can be embodied as software, hardware, firmware, electronic circuitry, or etc.

The embodiments described above are illustrative examples and it should not be construed that the present invention is limited to these particular embodiments. Thus, various changes and modifications may be effected by one skilled in the art without departing from the spirit or scope of the invention as defined in the appended claims.

1. A method of generating a heat transfer model for building energy, comprising:
developing, by a processor, a PDE model that describes heat transfer through building envelope of a building; and
developing, by the processor, an ODE model that describes the heat transfer and thermal balance in a space inside the building,
wherein a stepwise parameter estimation integrates the PDE model and the ODE model in generating the heat transfer model.

2. The method of claim 1, wherein the PDE model's heat transfer through the building envelope comprises surface convection and wall conduction.

3. The method of claim 1, wherein the stepwise parameter estimation comprises estimation of time-invariant parameters and time-variant parameters.

4. The method of claim 1, wherein the developing of the PDE model comprises estimating multipliers of physical parameters described in the PDE model, by minimizing a temperature difference between simulated and measured temperature profiles of inner and outer envelope surfaces described in the PDE model.

5. The method of claim 4, wherein the multipliers comprise heat conductivity of the building envelope, solar impact on different sides of the building envelope, and solar impact on different days.

6. The method of claim 1, wherein the developing of the ODE model comprises estimating multipliers of physical parameters of the ODE model associated with a heating gain through the building envelope and an internal heat gain, by minimizing temperature difference between simulated and measured temperature profiles inside the building described in the ODE model.

7. The method of claim 6, wherein the multipliers comprise overall convection from inside wall surfaces, solar heat gain through window and infiltration through openings of the building envelope, internal heat gain from zero or more occupants, lighting and one or more equipments.

8. The method of claim 1, wherein the developing of the PDE model comprises selecting a regularization coefficient from a set of values and testing a plurality of random initial values for PDE multipliers described in the PDE model.

9. The method of claim 1, wherein the developing of the ODE model comprises selecting a regularization coefficient from a set of values and testing a plurality of random initial values for ODE multipliers described in the ODE model.

10.-20. (canceled)
